(19) United States
(12) Patent Application Publication
(10) Pub. No.: US 2025/0334115 A1
(43) Pub. Date: Oct. 30, 2025

(54) MATERIAL SUPPLY SYSTEM

(71) Applicant: Century Technology (ShenZhen) Corp. LTD., Shen-zHEN (CN)

(72) Inventor: Kuo-Chih HUANG, Shen-zhen (CN)

(21) Appl. No.: 19/191,002

(22) Filed: Apr. 28, 2025

(30) Foreign Application Priority Data
Apr. 28, 2024 (CN) 2024 10530933.5

(51) Int. Cl. F04B 53/14; F04B 9/02

(52) U.S. Cl. CPC F04B 53/14; F04B 9/02

(57) ABSTRACT

A material supply system includes a tank, a piston plate, a pushing module, a pressure sensor, and a controller. The tank has an accommodation space and a discharge port. The piston plate is disposed in the accommodation space and is displaceable between a first position and a second position when actuated. A liquid chamber is defined between the piston plate and the discharge port. The pushing module, when driven, actuates the piston plate. The pressure sensor is configured to detect a pressure sensing value within the liquid chamber. The controller is configured to drive the pushing module during a supply procedure to maintain the pressure sensing value at a predetermined pressure threshold.

### CROSS-REFERENCE TO RELATED APPLICATION

This application claims priority to Chinese Patent Application No. CN 202410530933.5 filed on Apr. 28, 2024, the disclosures of which are incorporated herein in their entirety by reference.

### TECHNICAL FIELD

The present invention relates to a material supply system, specifically a liquid material supply system that can maintain a preset hydraulic pressure during both the replenishment and supply procedures.

### BACKGROUND

Currently, the supply of liquid materials, such as quantum dot materials, is typically achieved using compressed gas or the inherent weight of the liquid materials. However, during the supply process, the liquid material may not be supplied smoothly to the nozzle due to the expansion properties of the gas or the inertia of the material, resulting in uneven spraying of the liquid material.

### SUMMARY

In view of the above, the present invention provides a material supply system comprising a tank, a piston plate, a pushing module, a pressure sensor, and a controller. The tank has an accommodation space and a discharge port. The piston plate is disposed in the accommodation space and displaces between a first position and a second position when actuated. A liquid chamber is defined between the piston plate and the discharge port. The pushing module actuates the piston plate when driven. The pressure sensor is used to detect a pressure sensing value of the liquid chamber. The controller drives the pushing module during the supply procedure to maintain the pressure sensing value at a predetermined pressure threshold.

According to some embodiments, the system further includes a replenishment level sensor that issues a replenishment signal when the piston plate is at the second position; the controller, during the supply procedure and upon receiving the replenishment signal, closes the discharge port.

According to some embodiments, the system further includes a supply level sensor that issues a supply signal when the piston plate is at the first position; the tank further includes an inlet port that communicates with the liquid chamber; during the replenishment procedure, the controller closes the discharge port, opens the inlet port, and drives the pushing module to actuate the piston plate towards the first position. The controller, upon receiving the supply signal, closes the inlet port and drives the pushing module to maintain the pressure sensing value at the predetermined pressure threshold.

According to some embodiments, the tank further includes an exhaust port that communicates with the inlet port; the material supply system further includes an exhaust sensor positioned at the exhaust port, which issues an exhaust signal when triggered; during the exhaust procedure, the controller opens the inlet port and the exhaust port while closing the discharge port, and upon receiving the exhaust signal, the controller closes the inlet port and the exhaust port.

In summary, in some embodiments of the present invention, the material supply system's controller drives the pushing module to move the piston plate to push liquid material to the discharge port during the supply procedure. Throughout the movement of the piston plate, the pressure sensing value can be maintained at the predetermined pressure threshold, allowing the liquid material to be smoothly supplied through the discharge port to the outside of the tank. Additionally, during the supply procedure, as the pushing module drives the piston plate along with the movement of the liquid material, the controller can maintain the pressure sensing value at the predetermined pressure threshold, ensuring smooth injection of the liquid material into the liquid chamber.

### BRIEF DESCRIPTION OF THE DRAWINGS

The drawings are used for better understanding of the present invention, but not intended to limit the scope of the present invention.

FIG. 1 is a structural diagram of the material supply system according to some embodiments of the present invention.

FIG. 2 is a block diagram of the material supply system according to some embodiments of the present invention.

FIG. 3 is a structural diagram illustrating the material supply system during the supply procedure, where the piston plate moves from the first position to the second position, according to some embodiments of the present invention.

FIG. 4 is a structural diagram illustrating the material supply system during the replenishment procedure, where the piston plate moves from the second position to the first position, according to some embodiments of the present invention.

FIG. 5 is a structural diagram illustrating the material supply system during the exhaust procedure, where the piston plate is positioned at the second position, according to some embodiments of the present invention.

### DETAILED DESCRIPTION OF DISCLOSED EMBODIMENTS

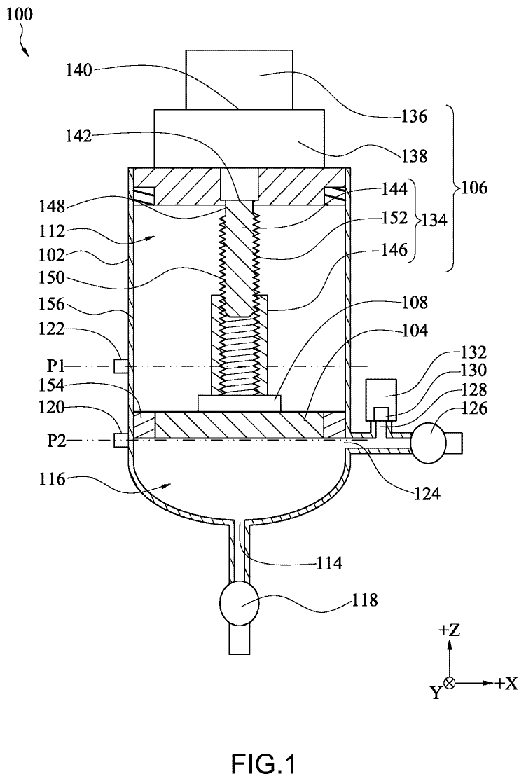

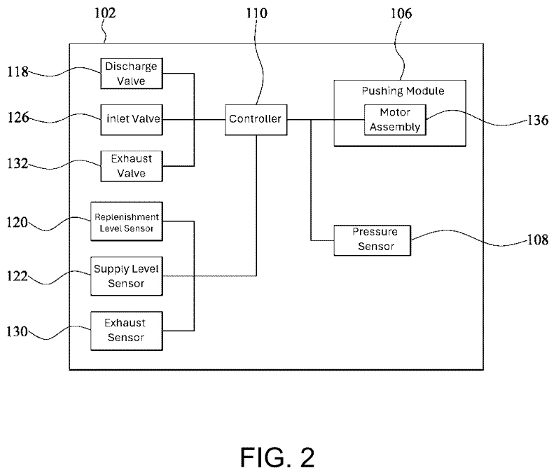

Please refer to FIG. 1 and FIG. 2. FIG. 1 is a structural diagram of the material supply system in some embodiments of the present invention. FIG. 2 is a block diagram of the material supply system in some embodiments of the present invention. As shown in FIG. 1 and FIG. 2, the material supply system 100 comprises a tank 102, a piston plate 104, a pushing module 106, a pressure sensor 108, and a controller 110. The tank 102 includes an accommodation space 112 and a discharge port 114. The piston plate 104 is disposed in the accommodation space 112 and is displaceable between a first position P1 and a second position P2 when actuated. A liquid chamber 116 is defined between the piston plate 104 and the discharge port 114. The pushing module 106, when driven, actuates the piston plate 104. The pressure sensor 108 is used to detect a pressure sensing value of the liquid chamber 116. The controller 110 drives the pushing module 106 during a supply procedure to maintain the pressure sensing value at a predetermined pressure threshold.

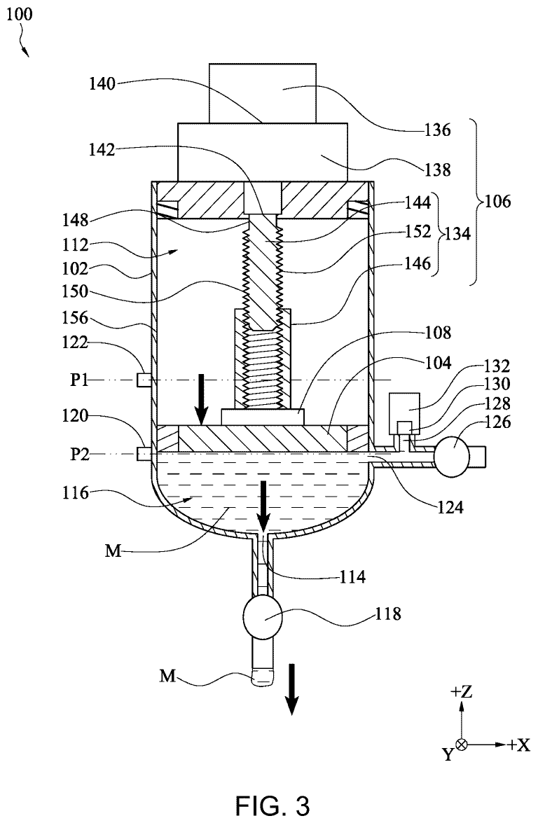

The tank 102 is designed to allow a liquid material M (as shown in FIG. 3) to be injected and retained within the liquid chamber 116 of the accommodation space 112, and to output the liquid material M through the discharge port 114. The liquid material M may be a quantum dot liquid with low viscosity. In some embodiments, the discharge port 114 includes a discharge valve 118. The discharge valve 118 can be controlled to open or close by the controller 110. For example, when the discharge valve 118 is opened, the liquid material M is discharged through the discharge port 114 to the exterior of the tank 102. The discharge valve 118 may also be controlled by an external control module (not shown in FIG. 2), which could be a manual valve or a control host. For example, if the external control module is a normally open manual valve, during the supply procedure, the manual valve can control the discharge valve 118 to open when manually activated (pressed). During the replenishment procedure, the manual valve can control the discharge valve 118 to close when manually activated again. The second position P2 is located between the first position P1 and the discharge port 114. The first position P1 is the starting position for executing the supply procedure, though it is not limited to this; the second position P2 is the starting position for executing a replenishment procedure (to be described later).

The piston plate 104 is disposed in the accommodation space 112 such that the liquid chamber 116 is formed between the piston plate 104 and the discharge port 114. It should be noted that the volume of the liquid chamber 116 varies based on the position of the piston plate 104. For example, when the piston plate 104 is at the first position P1, the liquid chamber 116 has its maximum volume, allowing it to store the maximum amount of liquid material M. When the piston plate 104 is at the second position P2, the volume of the liquid chamber 116 is reduced, allowing it to store a relatively smaller amount of liquid material M.

The pressure sensor 108 is located between the pushing module 106 and the piston plate 104 to measure the hydraulic pressure (referred to as the pressure sensing value) of the liquid material M within the liquid chamber 116. Specifically, the pressure sensing value may refer to the pressure exerted by the liquid material M on the piston plate 104. For example, during the replenishment procedure, after the liquid material M is injected into the liquid chamber 116, the liquid material M pushes against the piston plate 104, and the pressure sensor 108 located on the piston plate 104 can measure the hydraulic pressure of the liquid material M in the liquid chamber 116. Similarly, during the supply procedure, after the liquid material M is output from the liquid chamber 116 to the discharge port 114, the piston plate 104 pushes the liquid material M, and the pressure sensor 108 can measure the hydraulic pressure of the liquid material M in the liquid chamber 116.

The pushing module 106, when driven, can generate a first movement and a second movement, where the direction of the first movement is opposite to the direction of the second movement. For example, the direction of the first movement may be in the −Z direction of FIG. 1, and the direction of the second movement may be in the +Z direction of FIG. 1. For example, during the supply procedure, the controller 110 may drive the pushing module 106 to perform the first movement, thereby moving the piston plate 104 from the first position P1 to the second position P2. Conversely, during the replenishment procedure, the controller 110 may drive the pushing module 106 to perform the second movement, thereby moving the piston plate 104 from the second position P2 to the first position P1.

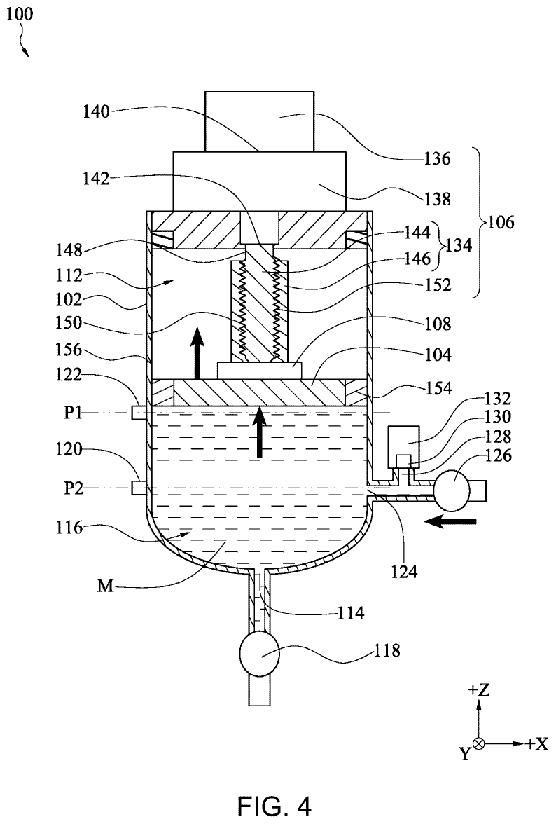

Please also refer to FIG. 1, FIG. 2, FIG. 3, and FIG. 4. FIG. 3 is a structural diagram illustrating the material supply system during the supply procedure, where the piston plate moves from the first position to the second position, according to some embodiments of the present invention. FIG. 4 is a structural diagram illustrating the material supply system during the replenishment procedure, where the piston plate moves from the second position to the first position, according to some embodiments of the present invention. As shown in FIG. 3, during the supply procedure, the controller 110 may issue a first control signal to drive the pushing module 106 to perform the first movement, thereby moving the piston plate 104 from the first position P1 to the second position P2. Conversely, as shown in FIG. 4, during the replenishment procedure, the controller 110 may issue a second control signal to drive the pushing module 106 to perform the second movement, thereby moving the piston plate 104 from the second position P2 to the first position P1. Additionally, during the process of driving the pushing module 106 to perform the first or second movement, the controller 110 adjusts the speed and position of the pushing module 106 based on the pressure sensing value. Under the condition that the pressure sensing value is maintained at the predetermined pressure threshold, the liquid material M within the liquid chamber 116 is controlled to maintain a stable flow rate. For example, during the supply procedure, the controller 110 drives the pushing module 106 to perform the first movement. As the piston plate 104 is moved by the pushing module 106 from the first position P1 to the second position P2, the piston plate 104 can stably push the liquid material M under the condition that the pressure sensing value is maintained at the predetermined pressure threshold, ensuring that the liquid material M is output at a predetermined flow rate through the discharge port 114. Similarly, during the replenishment procedure, the controller 110 drives the pushing module 106 to perform the second movement. As the piston plate 104 is moved by the pushing module 106 from the second position P2 to the first position P1, the piston plate 104 can apply or release pressure on the liquid material M under the condition that the pressure sensing value is maintained at the predetermined pressure threshold (which may involve adjusting the movement speed of the piston plate 104 to regulate the hydraulic pressure of the liquid material M), thereby ensuring that the liquid material M is injected into the liquid chamber 116 at a fixed flow volume and flow rate, and evenly distributing the liquid material M within the liquid chamber 116. For example, during the process of injecting the liquid material M into the liquid chamber 116, if the pressure sensor 108 measures that the pressure sensing value of the liquid material M is close to the predetermined pressure threshold (which may mean within 10% greater than the predetermined pressure threshold and/or within 10% less than the predetermined pressure threshold), the controller 110 drives the pushing module 106 to slow down the movement speed of the second movement, bringing the pressure sensing value in line with the predetermined pressure threshold. Conversely, if the pressure sensor 108 measures that the pressure sensing value of the liquid material M is greater than the predetermined pressure threshold, the controller 110 drives the pushing module 106 to speed up the movement of the second movement. In some embodiments, the controller 110 maintains the pressure sensing value within a range of +10% of the predetermined pressure threshold. If the pressure sensor 108 measures that the pressure sensing value of the liquid material M meets the predetermined pressure threshold, the controller 110 maintains the movement speed of the pushing module 106. The controller 110 may be, for example, a Central Processing Unit (CPU), a Microcontroller Unit (MCU), or a Programmable Logic Controller (PLC).

In some embodiments, the predetermined pressure threshold may refer to a value range. The following is an example of a value range. The predetermined pressure threshold includes a replenishment pressure range. When the piston plate 104 moves from the second position P2 to the first position P1, the pressure sensing value is maintained within the replenishment pressure range, which is from −10 kilopascals (KPa) to 100 kilopascals (KPa). The predetermined pressure threshold also includes a supply pressure range. When the pushing module 106 moves from the second position P2 to the first position P1, the pressure measurement value of the pushing module 106 is maintained within the supply pressure range, which is from −10 kilopascals (KPa) to 10 kilopascals (KPa).

As shown in FIG. 1 and FIG. 4, in some embodiments, the material supply system 100 further includes a replenishment level sensor 120. The replenishment level sensor 120 is located at the second position P2 and is configured to issue a replenishment signal when the piston plate 104 is located at the second position P2. When the controller 110 receives the replenishment signal during the supply procedure, it closes the discharge port 114. The replenishment level sensor 120 can be, for example, a non-contact sensor (such as an ultrasonic sensor or a laser level sensor). The replenishment level sensor 120 may issue a replenishment signal upon detecting the piston plate 104 or upon detecting that the liquid material M level is below the replenishment level sensor 120. For example, when detecting the piston plate 104, during the supply procedure, the material supply system 100 continuously outputs the liquid material M through the discharge port 114 to the exterior of the tank 102 under the condition that the pressure sensing value meets the predetermined pressure threshold. When the pushing module 106 moves the piston plate 104 to the second position P2, the replenishment level sensor 120 detects the piston plate 104 and issues a replenishment signal (the replenishment level sensor 120 may be a laser level sensor that detects the position of the piston plate 104 by reflecting laser light off the piston plate 104). At this point, the liquid material M is substantially at the second position P2, indicating that there is not enough liquid material M left in the tank 102 to continue the supply procedure. Alternatively, the material supply system 100 may use the second position P2 as a warning level, indicating that the remaining liquid material M in the tank 102 has reached a warning level and is not suitable for further supply procedures. For example, when detecting the liquid material M, if the pushing module 106 moves the piston plate 104 to the second position P2, the replenishment level sensor 120 detects the liquid material M and issues a replenishment signal.

As shown in FIG. 1 and FIG. 3, in some embodiments, the material supply system 100 further includes a supply level sensor 122. The supply level sensor 122 is configured to issue a supply signal when the piston plate 104 is at the first position P1. The supply level sensor 122 can be, for example, a non-contact sensor (such as an ultrasonic sensor or a laser level sensor). The supply level sensor 122 may issue a supply signal upon detecting the piston plate 104 or upon detecting that the liquid material M level is below the replenishment level sensor 120. For example, when detecting the piston plate 104, during the replenishment procedure, the material supply system 100 continuously injects the liquid material M into the liquid chamber 116 under the condition that the pressure sensing value meets the predetermined pressure threshold. When the liquid material M pushes the piston plate 104 to the first position P1, the supply level sensor 122 detects the piston plate 104 and issues a supply signal (the supply level sensor 122 may be a laser level sensor that detects the position of the piston plate 104 by reflecting laser light off the piston plate 104). At this point, the liquid material M is substantially at the first position P1, indicating that the tank 102 has stored enough liquid material M to perform the supply procedure. For example, when detecting the liquid material M, if the pushing module 106 moves the piston plate 104 to the first position P1, the supply level sensor 122 detects the liquid material M and issues a supply signal.

In some embodiments, the tank 102 further includes an inlet port 124, which communicates with the liquid chamber 116, allowing the liquid material M to be injected into the liquid chamber 116 through the inlet port 124. The controller 110 is configured to close the discharge port 114, open the inlet port 124, and drive the pushing module 106 to actuate the piston plate 104 to move toward the first position P1 during the replenishment procedure. In some embodiments, the inlet port 124 includes an inlet valve 126. The controller 110 controls the opening or closing of the inlet valve 126 based on the supply signal. For example, during the supply procedure, the controller 110 issues a first control signal based on the supply signal, causing the discharge valve 118 to open according to the first control signal so as to open the discharge port 114, and causing the inlet valve 126 to close according to the first control signal so as to seal the inlet port 124. The pushing module 106 then generates the first movement according to the first control signal, moving the piston plate 104 from the first position P1 to the second position P2 while maintaining the pressure sensing value within the predetermined pressure threshold. Conversely, during the replenishment procedure, the controller 110 issues a second control signal based on the replenishment signal, causing the discharge valve 118 to close according to the second control signal so as to seal the discharge port 114, and causing the inlet valve 126 to open according to the second control signal so as to open the inlet port 124. The pushing module 106 then generates the second movement according to the second control signal, moving the piston plate 104 from the second position P2 to the first position P1.

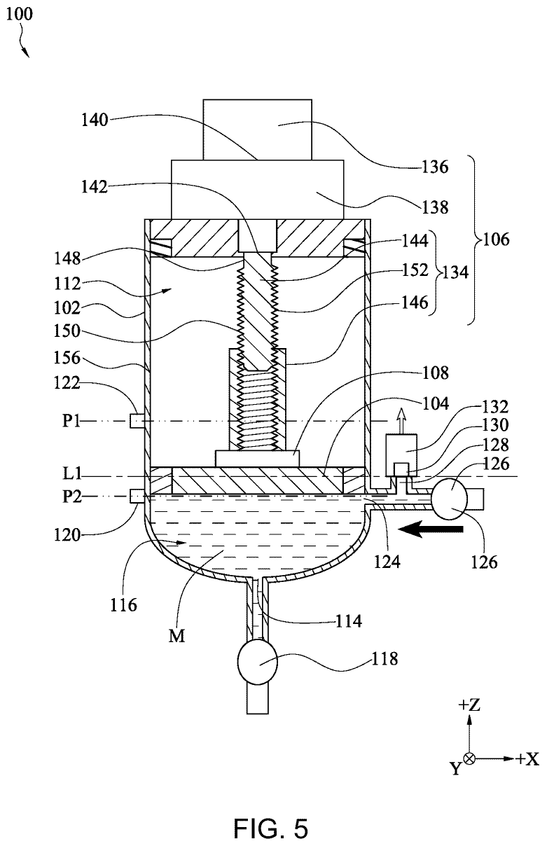

Please refer to FIGS. 1, 2, and 5 together. FIG. 5 is a structural diagram of the material supply system in the exhaust procedure, where the piston plate is located at the second position, according to some embodiments of the present invention. As shown in FIGS. 1, 2, and 5, in some embodiments, the tank 102 further includes an exhaust port 128. The exhaust port 128 is located at the inlet port 124 and connects the inlet port 124 to the exterior of the tank 102. The exhaust port 128 is designed to expel air from the liquid chamber 116 or the liquid material M (as will be explained later), preventing air from remaining in the liquid material M, which could affect the stability and hydraulic distribution of the liquid material M during the supply or replenishment procedures. The material supply system 100 further includes an exhaust sensor 130. The exhaust sensor 130 is located at the exhaust port 128 and is configured to issue an exhaust signal when triggered. The exhaust sensor 130 can be, for example, a non-contact sensor (such as an ultrasonic sensor or a laser level sensor). The exhaust sensor 130 may issue a supply signal when detecting the liquid material M.

During the prefabrication stage of the material supply system 100, the liquid chamber 116 (with the piston plate 104 positioned at the second position P2 during the prefabrication stage) has not yet been filled with liquid material M. When the liquid material M is injected into the liquid chamber 116 through a feeding device (not shown in the figures) at a fixed pressure, the air inside the liquid chamber 116 will be displaced by the liquid material M and pushed out through the exhaust port 128. This process constitutes the exhaust procedure. During the exhaust procedure, the liquid material M will diffuse from the liquid chamber 116 to the exhaust port 128. The exhaust sensor 130 detects the liquid material M and issues an exhaust signal (the exhaust sensor 130 can be a float-type liquid level sensor that determines the position of the liquid material by the position of the float). When the liquid material M is substantially at the exhaust port 128, this indicates that the liquid chamber 116 is fully filled with the liquid material M and that the air in the liquid chamber 116 has been expelled through the exhaust port 128. At this point, the liquid material M in the liquid chamber 116 is free of air, ensuring the stability of the liquid material M flow and consistent hydraulic distribution during subsequent supply and replenishment procedures.

The controller 110 is configured to open the inlet port 124 and the exhaust port 128 while closing the discharge port 114 during the exhaust procedure. In some embodiments, the exhaust port 128 includes an exhaust valve 132, which the controller 110 can control to open or close based on the exhaust signal. For example, when the exhaust sensor 130 detects the liquid material M, the exhaust sensor 130 issues the exhaust signal. The controller 110 issues a third control signal based on the exhaust signal, and the exhaust valve 132 opens or closes the exhaust port 128 according to the third control signal. In some embodiments, the replenishment level sensor 120, the supply level sensor 122, and the exhaust sensor 130 may be of the same or different types of sensors.

In some embodiments, the order of the exhaust procedure, supply procedure, and replenishment procedure may be interchangeable. For example, during the prefabrication stage, the controller 110 may control the discharge port 114 to close and the inlet port 124 to open. When the liquid material M is injected into the liquid chamber 116, the controller 110 can execute the exhaust procedure. If the piston plate 104 is at the second position P2 during the prefabrication stage, once the exhaust procedure is completed (as determined by the controller 110 when the exhaust sensor 130 issues the exhaust signal), the controller 110 can close the exhaust port 128 based on the exhaust signal and then initiate the replenishment procedure.

As shown in FIG. 5, in some embodiments, the exhaust port 128 is located on a horizontal axis L1, which lies between the first position P1 and the second position P2. Since the exhaust port 128 is positioned above the second position P2, when the liquid material M is injected into the liquid chamber 116, the liquid material M can gradually displace the air within the liquid chamber 116 or within the liquid material M, expelling it through the exhaust port 128. Once the liquid material M completely fills the liquid chamber 116, the air can be entirely expelled through the exhaust port 128.

As shown in FIG. 1, in some embodiments, the pushing module 106 further includes a linkage assembly 134 and a motor assembly 136. The linkage assembly 134 is pivoted in the tank 102 and connected to the piston plate 104. The linkage assembly 134 is used to move the piston plate 104 to either the first position P1 or the second position P2. The motor assembly 136 is connected to the linkage assembly 134. When the motor assembly 136 is driven, it actuates the linkage assembly 134. The controller 110 drives the motor assembly 136 to generate a rotational motion during the supply and replenishment procedures. The rotational motion may refer to rotation along the X-axis direction shown in FIG. 1. The motor assembly 136 can be, for example, a servo motor or a stepper motor, enabling the controller 110 to perform precise motion control of the motor assembly 136 with micron-level accuracy.

As shown in FIG. 1, in some embodiments, the pushing module 106 also includes a reduction assembly 138. The reduction assembly 138 has an input end 140 and an output end 142, with the linkage assembly 134 pivotally connected to the output end 142 and the motor assembly 136 connected to the input end 140. The reduction assembly 138 increases the force input from the motor assembly 136 at the input end 140 and outputs it to the linkage assembly 134 via the output end 142. This enables the linkage assembly 134 to drive the piston plate 104 to push the liquid material M within the liquid chamber 116. The reduction assembly 138 may be a planetary gear assembly with an internal gear ratio of 1:20. It should be noted that the internal gear ratio of the planetary gear assembly can be determined based on the precision required for the supply procedure or the viscosity of the liquid material, allowing the controller 110 to control the precise movement of the piston plate 104 and adjust the force exerted by the motor assembly 136 on the piston plate 104.

As shown in FIG. 1, in some embodiments, the linkage assembly 134 includes a lead screw 144 and a shaft sleeve 146. The lead screw 144 is pivoted in the tank 102 and includes a fixed section 148 and a linkage section 150. The output end 142 of the reduction assembly 138 engages with the fixed section 148. One end of the shaft sleeve 146 is pivotally connected to the linkage section 150, while the other end is connected to the piston plate 104. The motor assembly 136 drives the rotation of the lead screw 144 to move the piston plate 104. Specifically, the rotational direction of the lead screw 144 can be the same as the direction of the rotational motion of the motor assembly 136. During the rotation of the lead screw 144, the shaft sleeve 146 moves axially relative to the lead screw 144 (in the Z-axis direction as shown in FIG. 1), driving the piston plate 104 to move between the first position P1 and the second position P2. In some embodiments, the reduction assembly 138 (such as a planetary gear assembly) and the lead screw 144 have a gear backlash of less than 10 micrometers (μm). This allows the motor assembly 136 to precisely control the rotation of the lead screw 144 through the reduction assembly 138. For example, during the supply procedure, the motor assembly 136 drives the shaft sleeve 146 to rotate, causing the piston plate 104 to move precisely to the second position P2, thereby squeezing the liquid material M towards the discharge port 114. Alternatively, during the replenishment procedure, as the liquid material M is injected into the liquid chamber 116 and pushes the piston plate 104, the motor assembly 136 drives the shaft sleeve 146 to rotate, allowing the piston plate 104 to move precisely to the first position P1 along with the liquid material M under the condition that the pressure sensing value meets the predetermined pressure threshold.

In some embodiments, the lead screw 144 includes a threaded portion 152, and the shaft sleeve 146 moves along the threaded portion 152. The pitch of the threaded portion 152 is substantially equal to 0.5 millimeters. This configuration allows the shaft sleeve 146 to move precisely relative to the lead screw 144, enabling the controller 110 to maintain the precise movement of the piston plate 104 (i.e., keeping the pressure sensing value within the predetermined pressure threshold).

As shown in FIG. 1, in some embodiments, the piston plate 104 further includes a sealing ring 154. The sealing ring 154 is attached to the side of the piston plate 104 and extends to the inner wall surface 156 of the tank 102, allowing the piston plate 104 to tightly adhere to the inner wall surface 156. When both the discharge port 114 and the inlet port 124 are closed, the liquid chamber 116 can form a sealed space.

In some embodiments, one or more of the discharge port 114, the inlet port 124, the exhaust port 128, the sealing ring 154, the discharge valve 118, the inlet valve 126, and the exhaust valve 132 are coated with an anti-corrosion material. Examples of such anti-corrosion materials include Teflon coating, fluorocarbon coating, fluorine grease, or polytetrafluoroethylene (PTFE). This coating helps prevent corrosion by the liquid material M and ensures the sealing integrity of the discharge port 114, the inlet port 124, the exhaust port 128, the sealing ring 154, the discharge valve 118, the inlet valve 126, and the exhaust valve 132.

In some embodiments, one or more of the piston plate 104, the lead screw 144, and the shaft sleeve 146 are made of heat-treated steel to enhance the rigidity of the material itself. This ensures that the components of the material supply system 100 can maintain precision even after prolonged operation, thereby ensuring the accurate flow of the liquid material M.

In some embodiments, either the tank 102 or the piston plate 104 is coated with an anti-corrosion layer. The anti-corrosion layer may be either a Teflon coating or a hard Teflon coating, protecting the tank 102 and the piston plate 104 from corrosion by the liquid material M.

In summary, in some embodiments of the material supply system 100 of the present invention, the controller 110 drives the piston plate 104 via the pushing module 106 during the supply procedure to push the liquid material M to the discharge port 114. During the movement of the piston plate 104, the pressure sensing value can be maintained within the predetermined pressure threshold, allowing the liquid material M to be smoothly supplied through the discharge port 114 to the exterior of the tank 102. Additionally, during the supply procedure, as the pushing module 106 drives the piston plate 104 along with the movement of the liquid material M, the controller 110 can control the pressure sensing value to remain within the predetermined pressure threshold, ensuring that the liquid material M can be smoothly injected into the liquid chamber 116.

What is claimed is:

1. A material supply system, comprising:
a tank having an accommodation space and a discharge port;
a piston plate disposed in the accommodation space and displaceable between a first position and a second position when actuated, the piston plate and the discharge port defining a liquid chamber therebetween;
a pushing module that, when driven, actuates the piston plate;
a pressure sensor configured to detect a pressure sensing value of the liquid chamber; and
a controller configured to drive the pushing module during a supply procedure to maintain the pressure sensing value at a predetermined pressure threshold.

2. The material supply system according to claim 1, further comprising a replenishment level sensor configured to issue a replenishment signal when the piston plate is at the second position; wherein the controller, during the supply procedure and upon receiving the replenishment signal, closes the discharge port.

3. The material supply system according to claim 1, further comprising a supply level sensor configured to issue a supply signal when the piston plate is at the first position; wherein the tank further comprises an inlet port communicating with the liquid chamber; the controller is configured to close the discharge port, open the inlet port, and drive the pushing module to actuate the piston plate to move toward the first position during a replenishment procedure; and the controller, upon receiving the supply signal, closes the inlet port and drives the pushing module to maintain the pressure sensing value at the predetermined pressure threshold.

4. The material supply system according to claim 3, wherein the tank further comprises an exhaust port communicating with the inlet port; the material supply system further comprises an exhaust sensor located at the exhaust port and configured to issue an exhaust signal when triggered; the controller is configured to open the inlet port and the exhaust port and close the discharge port during an exhaust procedure, and upon receiving the exhaust signal, the controller closes the inlet port and the exhaust port.

5. The material supply system according to claim 4, wherein the exhaust port is located on a horizontal axis, the horizontal axis being located between the first position and the second position.

6. The material supply system according to claim 4, wherein the piston plate further comprises a sealing ring, the sealing ring being attached to a side of the piston plate and extending to an inner wall surface of the tank.

7. The material supply system according to claim 6, wherein at least one of the discharge port, the inlet port, the exhaust port, or the sealing ring is coated with an anti-corrosion material.

8. The material supply system according to claim 3, wherein the pushing module further comprises:
a linkage assembly pivoted in the tank and connected to the piston plate, configured to move the piston plate between the first position and the second position; and
a motor assembly connected to the linkage assembly, wherein the motor assembly, when driven, causes the linkage assembly to generate a rotational motion;
wherein the controller is configured to drive the motor assembly during the supply procedure and the replenishment procedure.

9. The material supply system according to claim 8, wherein the pushing module further comprises a reduction assembly having an input end and an output end, the linkage assembly being pivotally connected to the output end, and the motor assembly being connected to the input end.

10. The material supply system according to claim 9, wherein the linkage assembly comprises:
a lead screw pivoted in the tank, the lead screw having a fixed section and a linkage section, the output end of the reduction assembly engaging with the fixed section; and
a shaft sleeve, one end pivotally connected to the linkage section, the other end connected to the piston plate, wherein the motor assembly drives the lead screw to rotate to move the piston plate.

11. The material supply system according to claim 10, wherein the lead screw comprises a threaded portion, and the shaft sleeve is movable along the threaded portion, the pitch of the threaded portion being substantially equal to 0.5 millimeters.

12. The material supply system according to claim 11, wherein at least one of the piston plate, the lead screw, or the shaft sleeve is made of heat-treated steel.

13. The material supply system according to claim 9, wherein the reduction assembly is a planetary gear assembly, and the planetary gear assembly has an internal gear ratio of 1:20.

14. The material supply system according to claim 13, wherein the planetary gear assembly and the lead screw of the linkage assembly have a gear backlash of less than 10 micrometers (μm).

15. The material supply system according to claim 1, wherein the predetermined pressure threshold includes a replenishment pressure range, and the pressure sensing value is maintained within the replenishment pressure range when the piston plate moves from the second position to the first position.

16. The material supply system according to claim 15, wherein the replenishment pressure range is from −10 kilopascals (KPa) to 100 kilopascals (KPa).

17. The material supply system according to claim 1, wherein the predetermined pressure threshold includes a supply pressure range, and the pressure measurement value of the pushing module is maintained within the supply pressure range when the pushing module moves from the second position to the first position.

18. The material supply system according to claim 17, wherein the supply pressure range is from −10 kilopascals (KPa) to 10 kilopascals (KPa).

19. The material supply system according to claim 1, wherein at least one of the tank or the piston plate is coated with an anti-corrosion layer, the anti-corrosion layer being either a Teflon coating or a hard Teflon coating.
